(19) United States
(12) Patent Application Publication
(10) Pub. No.: US 2026/0122237 A1
(43) Pub. Date: Apr. 30, 2026

(54) LOW COMPLEXITY SECONDARY TRANSFORM FOR TRANSFORM BLOCKS USING 1D PRIMARY TRANSFORMS

(71) Applicant: Tencent America LLC, Palo Alto, CA (US)

(72) Inventors: Madhu PERINGASSERY KRISHNAN, Palo Alto, CA (US); Liang ZHAO, Palo Alto, CA (US); Ting-Lan LIN, Palo Alto, CA (US); Tianqi LIU, Palo Alto, CA (US); Shan LIU, Palo Alto, CA (US); Jayasingam ADHURAN, Palo Alto, CA (US)

(21) Appl. No.: 19/365,037

(22) Filed: Oct. 21, 2025

Related U.S. Application Data
(60) Provisional application No. 63/712,364, filed on Oct. 25, 2024.

(51) Int. Cl. H04N 19/122; H04N 19/167; H04N 19/176; H04N 19/60

(52) U.S. Cl. CPC H04N 19/122; H04N 19/167; H04N 19/176; H04N 19/60

(57) ABSTRACT

The various implementations described herein include methods and systems for coding video. An example method includes receiving a video bitstream comprising a plurality of blocks that includes a current block. The method also includes, when a one-dimensional (1D) primary transform is used for the current block, determining a support region based on the 1D primary transform, selecting a secondary transform based on the 1D primary transform and the support region and reconstructing the current using the secondary transform.

### RELATED APPLICATIONS

This application claims priority to U.S. Provisional Patent Application No. 63/712,364, entitled “Low Complexity Secondary Transform for Transform Blocks Using 1D Primary Transforms” filed Oct. 25, 2024, which is hereby incorporated by reference in its entirety.

### TECHNICAL FIELD

The disclosed embodiments relate generally to video coding, including but not limited to systems and methods for transform coding.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes amongst other things, systems and methods of video (image) compression, more specifically related to the application of a secondary transform based on characteristics of a 1D primary transform that is applied. The application of the secondary transform is preceded by a selection of a support region that may be based on characteristics of the 1D primary transform (e.g., whether the 1D primary transform is performed row-wise or column-wise). By adaptively selecting a support region for the application of a secondary transform, a more accurate and/or efficient transform output that improves the quality of the coding (e.g., more accurate encoding/decoding) may be provided. For example, the residual block to which the secondary transform set is applied may have directionality and/or distributions associated with the output of the 1D primary transform and/or coded information. Limiting the secondary transform to the support region can reduce coding time.

In accordance with some embodiments, a method of video decoding includes (i) receiving a video bitstream (e.g., a coded video sequence) comprising a plurality of blocks, including a current block; and (ii) when a one-dimensional (1D) primary transform is used for the current block: (a) determining a support region based on the 1D primary transform; (b) selecting a secondary transform based on the 1D primary transform and the support region; and (c) reconstructing the current block using the secondary transform.

In accordance with some embodiments, a method of video encoding includes (i) receiving video data (e.g., a source video sequence) comprising a plurality of blocks that includes a current block; and (ii) when a one-dimensional (1D) primary transform is used for the current block: (a) determining a support region based on the 1D primary transform; (b) selecting a secondary transform based on the 1D primary transform and the support region; and (c) encoding the current block using the secondary transform.

In accordance with some embodiments, a method of video media bitstream generation includes: (i) generating a video bitstream, including: when a one-dimensional (1D) primary transform is used for the current block: (a) determining a support region based on the 1D primary transform; (b) selecting a secondary transform based on the 1D primary transform and the support region; and (c) encoding the current block using the secondary transform; and (ii) transmitting the video bitstream including the encoded current block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates an example transform process involving secondary transforms in accordance with some embodiments.

FIG. 4B illustrates different example support regions in accordance with some embodiments.

FIGS. 4C-4F illustrate different support regions and scan orders in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques related to selecting an appropriate support region for applying a secondary transform after a 1D primary transform has been performed on a current block. A residual block of the current block may have directionality and/or distributions associated with the output of the 1D primary transform; therefore, a suitable support region may be selected after the 1D primary transform to correspond to the directionality and/or distributions for the secondary transform. By adaptively selecting the support region for performing a secondary transform, for example, based on the output of the 1D primary transform, a more accurate and/or efficient transform kernel that improves the quality of the coding (e.g., more accurate encoding/decoding) may be selected.

For example, the techniques described herein include (1) enabling secondary transforms specifically for transform blocks that use 1D primary transforms applied either row-wise or column-wise, which was not previously addressed in conventional systems; (2) adaptively determining support regions based on the directionality of the 1D primary transform, e.g., where row-wise transforms utilize support regions that exclude high-frequency columns, and column-wise transforms utilize support regions that exclude high-frequency rows; (3) implementing directional vectorization schemes that align with the primary transform direction, using row-based scan orders for row-wise transforms and column-based scan orders for column-wise transforms; and (4) providing transform kernel size adaptation based on block dimensions to optimize computational efficiency. These techniques provide significant technical benefits including: reduced computational complexity by limiting secondary transform application to relevant low-frequency coefficients; improved compression efficiency through better exploitation of directional correlations in residual data; enhanced coding quality by matching secondary transform characteristics to the specific directionality patterns created by 1D primary transforms; and reduced encoding time by constraining the secondary transform to optimally-sized support regions rather than processing entire transform blocks.

### Example Systems and Devices

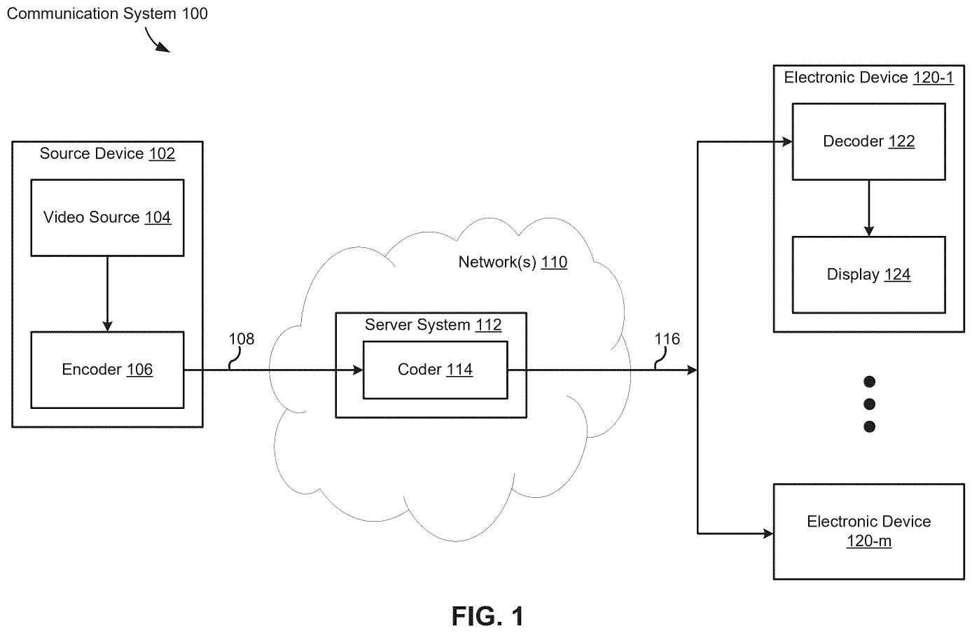

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

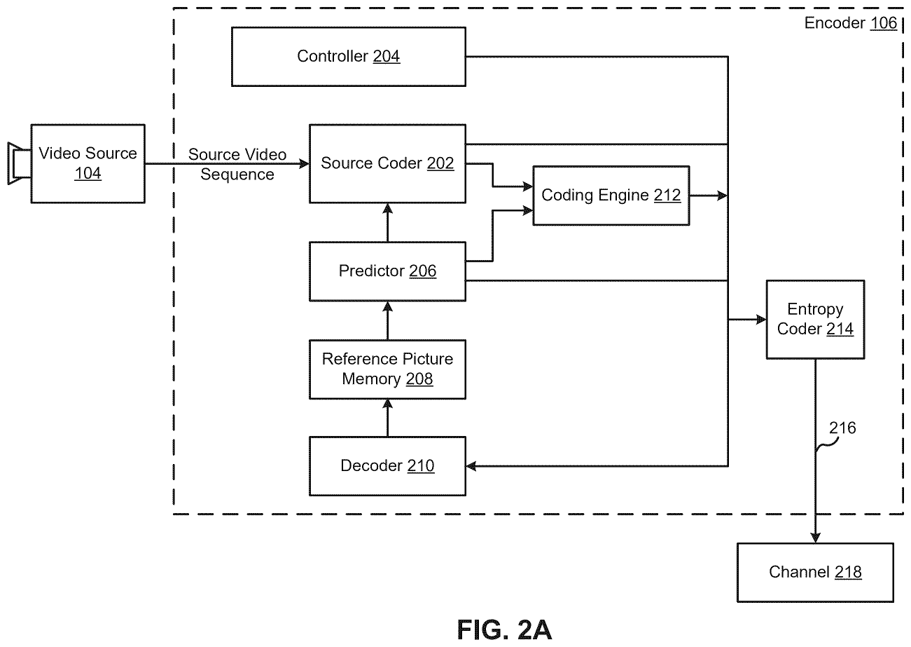

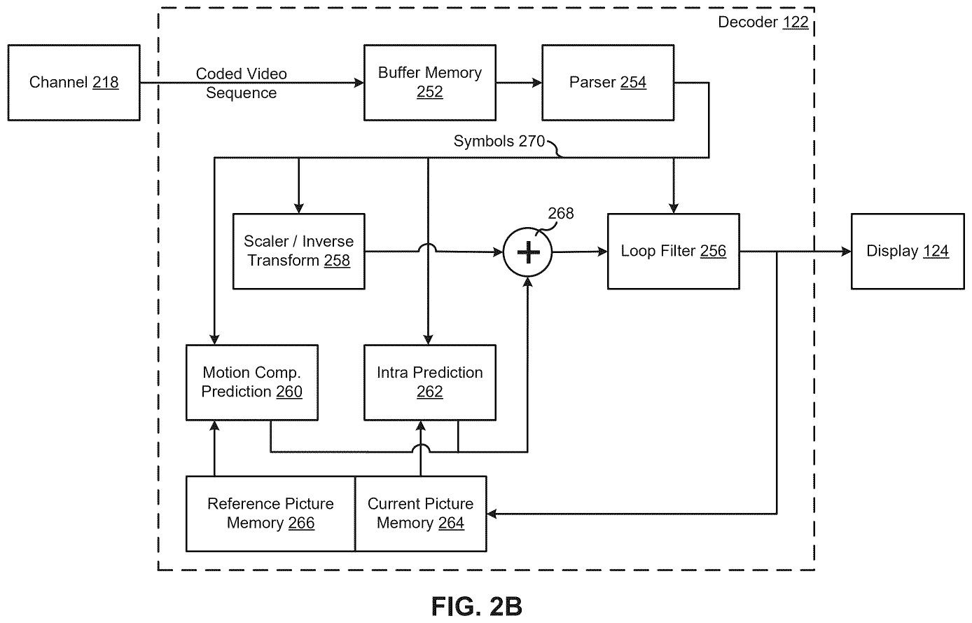

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, e.g., coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, e.g., Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (e.g., blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, e.g., coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, e.g., information used to manage operation of the decoder component 122, and/or information to control a rendering device such as the display 124. The control information for the rendering device(s) may be in the form of, e.g., Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, e.g., X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, e.g., parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, e.g., megasamples per second), maximum reference picture size, and so on. Limits set by levels can, in some cases, be further restricted through Hypothetical Reference Decoder (HRD) specifications and metadata for HRD buffer management signaled in the coded video sequence.

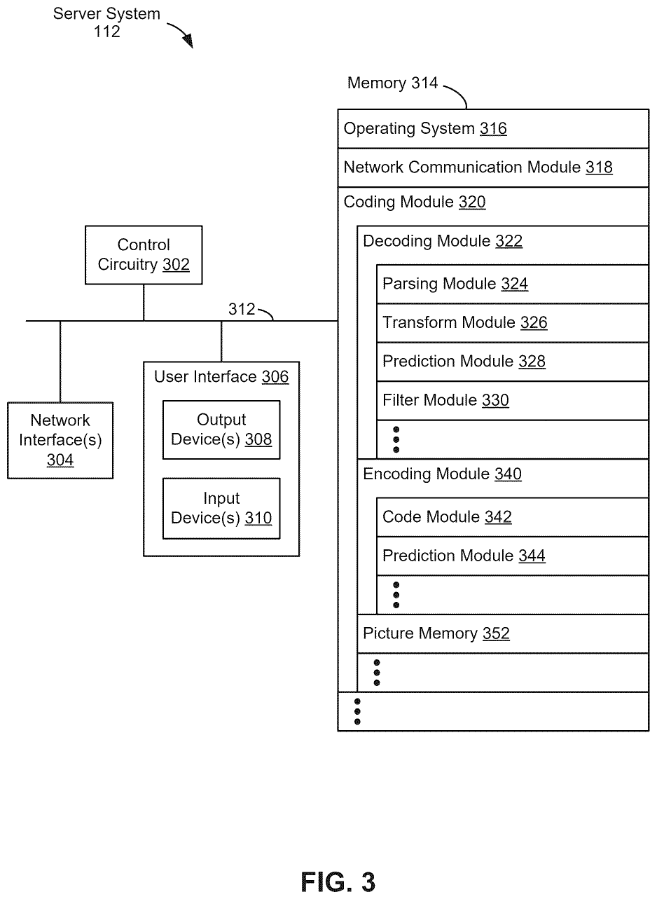

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). As described above, an intra prediction and/or inter prediction is performed on a current block to generate a prediction block. A residual block that includes a set of residues is generated by subtracting the prediction block from the current block.

A transform set is a grouping of one or more transform types (the transform types can be primary, secondary, separable or non-separable). Each entry in the transform set is called a transform candidate. For each block, a transform candidate selected from a transform set may be signaled or implicitly identified for performing the forward/backward transform process. The methods and systems described herein include the application of secondary transforms on intra or inter coded blocks using 1D primary transforms. As used herein, the term “partition” may refer to block partitioning or transform partitioning.

Transform coding may be applied to the residual block to remove potential spatial correlations. A transform may refer to a primary transform (e.g., a multiple transform selection (MTS) or a non-separable primary transform (NSPT)), or a secondary transform (e.g., a non-separable secondary transform (NSST) or a low frequency non-separable transform (LFNST)). In some embodiments, compressing a video frame with intra prediction, includes applying a primary transform on the residual block. Thereafter, one or more secondary transform kernels of an intra secondary transform set (IST) are further applied on top of the coefficients obtained as the output of primary transform to reduce the redundancy.

A primary transform may belong to the family of sinusoidal transforms (DCT's, DST's, flipped versions of DCT's and ADST's), Karhunen-Loève Transform (KLTs), Learned Group Transform (LGTs), or Data Driven Trained Transforms (DDT). DCT may refer to any transforms that use a transform kernel originating from the discrete cosine transform basis (e.g., DCT type 2), and DST/ADST may refer to any transforms that use a transform kernel originating from the discrete sine transform basis (e.g., DST type 4 or 7). An example primary transform may belong to the family of generalized line graph transforms (LGT) or it may be a training-based kernel. An example secondary transform set may be a grouping of one or more secondary transform kernels. Unique or common secondary transform sets may be defined for each primary transform type, and/or intra or inter mode type. As used herein, the term “intra coded block” may refer to a block coded using an intra prediction mode. As used herein, the term “inter coded block” may refer to a block that is coded by one or more inter prediction only modes, to a block that is coded by a combination of intra and inter prediction modes, or to a block that is coded using a block vector that is used to fetch a prediction block within the same frame, e.g., intra block copy.

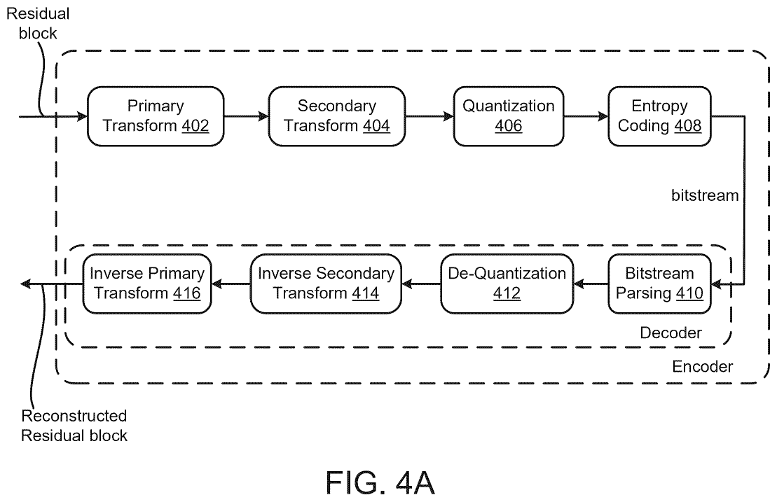

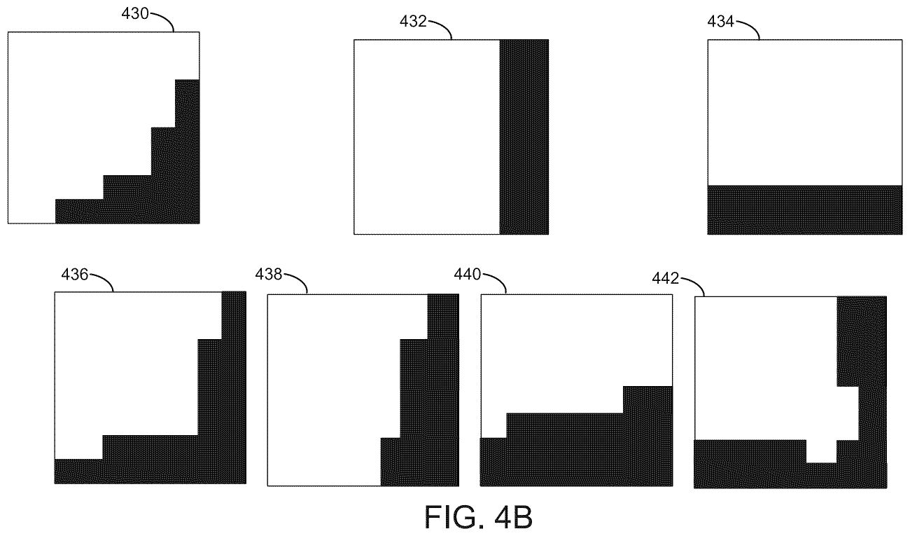

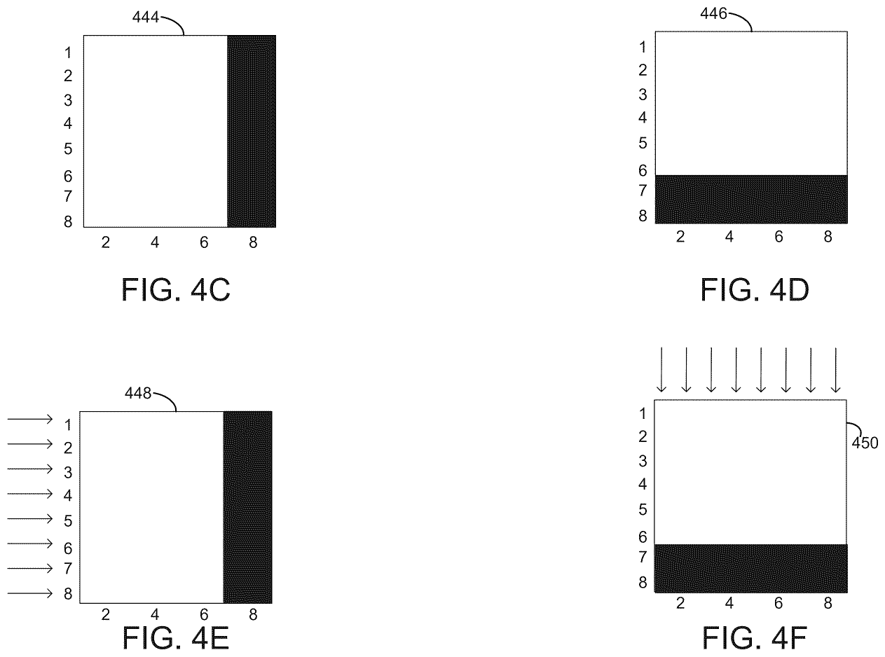

The use of IST in the encoding and decoding process is illustrated in FIG. 4A. In some embodiments, a current block includes a set of samples (e.g., pixel blocks) while a prediction block includes a set of predictions that correspond to the set of samples. In some embodiments, the prediction block is subtracted from the current block to generate a residual block that includes a set of residues. For example, respective differences are calculated between each sample and the corresponding prediction. FIG. 4 shows a primary transform 402 being applied to a residual block (e.g., corresponding to an intra prediction block). A secondary transform 404 is applied to the output of the primary transform 402. A secondary transform is an additional transform process subsequent to the primary transform. For example, in NSST, a non-separable secondary transform is applied to lower-frequency coefficients so that computational complexity for non-separable transform may be reduced. Quantization 406 is applied to the output of the secondary transform 404 and the resulting quantized coefficients are entropy encoded 408 and signaled via a video bitstream. The video bitstream is parsed 410 (e.g., at a decoder) and the quantized coefficients are de-quantized 412. An inverse secondary transform 414 is applied to the de-quantized data and an inverse primary transform 416 is applied to the output of the secondary transform 414. In this way, a reconstructed residual block is generated.

Notably, the transforms performed during decoding of the video bitstream may be inverses of the transformed performed during encoding of the video bitstream, and are sometimes referred to as “inverse transforms”. For simplicity, the transformations described herein may be referred to as “transforms” whether performed during encoding or decoding.

In some embodiments, the residual block undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residual block. The reconstructed residual block is combined with the predicted block (e.g., reconstructed residues of the reconstructed residual block are added to predictions of the prediction block) to generate a reconstructed block corresponding to the current block.

Using the previously decoded information may allow a secondary transform set to be adaptively selected for a residual block of the current block. By using a subset of all available secondary transform sets, fewer bits may be used to signal the selected secondary transform set from the subset of secondary transform sets.

In some embodiments, a secondary transform is applied to low frequency transform coefficients resulting from the application of a primary transform on an intra or inter coded block. The low frequency transform coefficients from a specific region of the transform block, hereinafter also sometimes referred to as a support region, are first vectorized using a scan order and then secondary transform is applied. Some example support regions are shown in FIG. 4B. The support region can be a square or rectangular block (e.g., support region 432 or support region 434) from the top left quadrant of the transform block. The support regions can also have arbitrary shapes, such as support regions 430, 436, 438, 440, and 442.

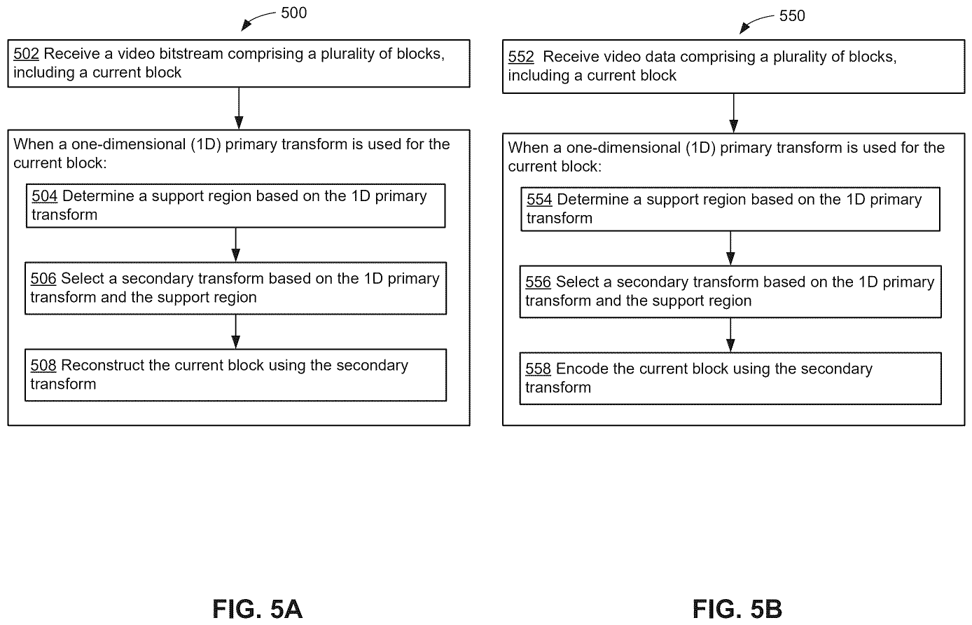

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream comprising a plurality of blocks that includes a current block. When a one-dimensional (1D) primary transform is used for the current block, the system determines (504) a support region based on the 1D primary transform. The system selects (506) a secondary transform based on the 1D primary transform and the support region. The system reconstructs (508) the current block using the secondary transform (e.g., a transform that is the inverse of a secondary transform applied during encoding). In this way, a secondary transform is applied on intra or inter transform blocks that use 1D primary transforms.

In some embodiments, a secondary transform is applied on intra or inter transform blocks using 1D primary transforms. In some embodiments, a secondary transform is enabled if the primary transform is applied only either to rows or columns (1D primary transform) of a transform block. In some embodiments, for transform blocks using 1D primary transforms, support regions as shown in FIG. 4C and FIG. 4D are defined.

In some embodiments, if a 1D primary transform is applied row-wise, support region shown in FIG. 4C is used for determining the low frequency coefficients. For example, the support region 444 shown in FIG. 4C shows the last two columns, which correspond to the highest frequencies, being removed (as indicated by the black shading). In some embodiments, if a 1D primary transform is applied column-wise, support region shown in FIG. 4D is used for determining the low frequency coefficients. For example, the support region 446 shown in FIG. 4D shows the last two rows, which correspond to the highest frequencies, being removed (as indicated by the black shading).

In some embodiments, if a 1D primary transform is applied row-wise, the primary transform coefficients in each row are vectorized using a row-wise scan order as shown for the support region 448 in FIG. 4E. For example, the vector may be a single column vector with 48 entries, 6 entries for each of the 8 rows shown in FIG. 4E (e.g., the last two entries from each of the 8 rows are removed, as indicated by the black shading). A secondary transform is applied on the vectorized coefficients from each row. For example, the secondary transform is applied on the 1×48 vector.

In some embodiments, if a 1D primary transform is applied column-wise, the primary transform coefficients in each column are vectorized using a column-wise scan order as shown in FIG. 4F. A secondary transform is applied on the vectorized coefficients from each column.

In some embodiments, transform blocks using 1D primary transform include multiple transform sets with multiple kernels in each set. In some embodiments, different transform sets (e.g., for secondary transforms) and kernels are used for different 1D primary transform types. For example, the different secondary transform sets correspond to different matrices, such as non-separable matrices that may be derived from data. In some embodiments, for the same 1D primary transform type, different transform sets and kernels may be used depending on whether the primary transform is applied row-wise or column-wise. For example, the secondary transform is derived based on the primary transforms that are used, and the matrices or kernels may include hard coded values in a table of values, and a specific matrix is selected based on the 1D primary transform. In some embodiments, for the same 1D primary transform type, different transform sets and kernels may be used depending on the support regions as shown in FIGS. 4B, 4C, 4D, 4E and 4F.

In some embodiments, transform kernels of different sizes are used for transform blocks of different sizes. In some embodiments, for transform blocks with width or height ≤8, a support region with width or height ≤4 is defined. In this case, the kernel size is M×N wherein (M≤4 and N≤4). In some embodiments, for transform blocks with width or height ≥8, a support region with width or height ≤8 is defined. In this case, the kernel size is M×N wherein (M≤8 and N≤8).

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data including a plurality of blocks that includes a current block. When a one-dimensional primary transform is used for the current block, the system determines (554) a support region based on the 1D primary transform, the system selects (556) a secondary transform based on the 1D primary transform and the support region and the system encodes (558) the current block using the secondary transform. As described previously, the encoding process may mirror the decoding processes described herein (e.g., the transform selection embodiments described above). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 500) of video decoding. In some embodiments, the method is performed at a computing system (e.g., the server system 112) having memory and control circuitry. In some embodiments, the method is performed at a source coding component (e.g., the source coder 202), a coding engine (e.g., the coding engine 212), and/or an entropy coder (e.g., the entropy coder 214). The method includes: (i) receiving a video bitstream comprising a plurality of blocks, including a current block; and (ii) when a one-dimensional (1D) primary transform is used for the current block: (a) determining a support region based on the 1D primary transform; (b) selecting a secondary transform based on the 1D primary transform and the support region; and (c) reconstructing the current block using the secondary transform. In this way, a secondary transform is applied on intra or inter transform blocks that are using 1D primary transforms. In some embodiments, the 1D primary transform belongs to the family of sinusoidal transforms (DCT's, DST's, flipped versions of DCT's and ADST's), Karhunen-Loève Transform (KLTs), Learned Group Transform (LGTs), or Data Driven Trained Transforms (DDT). In some embodiments, the secondary transform is a non-separable secondary transform (NSST) or a low frequency non-separable transform (LFNST). In some embodiments, the secondary transform is applied to low frequency transform coefficients resulting from the application of the 1D primary transform on an intra or inter coded block. In some embodiments, the current block is an intra coded block that corresponds to a block coded using an intra prediction mode. In other embodiments, the current block is an inter coded block that refers to a block that is coded by one or more inter prediction only modes, a block that is coded by a combination of intra and inter prediction modes, or a block that is coded using a block vector that is used to fetch a prediction block within the same frame (e.g., intra block copy).

(A2) In some embodiments of A1, the secondary transform is applied when the 1D primary transform is applied to one of: one or more rows of the current block, or one or more columns of the current block. For example, secondary transform may be enabled if the primary transform is applied only either to rows or columns (1D primary transform) of a transform block. In some embodiments, the 1D primary transform is applied row-wise, e.g., the transform is applied horizontally across each row of the transform block while leaving the columns unchanged. In other embodiments, the 1D primary transform is applied column-wise, e.g., the transform is applied vertically down each column of the transform block while leaving the rows unchanged. In some embodiments, the secondary transform is specifically enabled for transform blocks that use 1D primary transforms applied either row-wise or column-wise, which was not previously addressed in conventional systems. In some embodiments, the application of the secondary transform provides improved compression efficiency through better exploitation of directional correlations in residual data that result from the directional nature of the 1D primary transform.

(A3) In some embodiments of A1 or A2, the support region is based on whether the 1D primary transform is horizontal or vertical. For example, for transform blocks using 1D primary transforms, support regions as shown in FIG. 4C and FIG. 4D are defined. As an example, if 1D primary transform is applied row-wise, support region shown in FIG. 4C is used for determining the low frequency coefficients. As another example, if 1D primary transform is applied column-wise, support region shown in FIG. 4D is used for determining the low frequency coefficients. In some embodiments, when the 1D primary transform is applied row-wise (horizontal), the support region excludes high-frequency columns, e.g., the last two columns which correspond to the highest frequencies are removed or excluded from the support region. In some embodiments, when the 1D primary transform is applied column-wise (vertical), the support region excludes high-frequency rows, e.g., the last two rows which correspond to the highest frequencies are removed or excluded from the support region. In some embodiments, the adaptive selection of support regions based on the directionality of the 1D primary transform provides reduced computational complexity by limiting secondary transform application to relevant low-frequency coefficients. In some embodiments, the support region can be a square or rectangular block from the top left quadrant of the transform block, or it can have arbitrary shapes as shown in FIG. 4B. In some embodiments, the support region is determined to correspond to the directionality and/or distributions associated with the output of the 1D primary transform.

(A4) In some embodiments of any of A1-A3, the method further comprising when the 1D primary transform is applied row-wise, vectorizing coefficients in each row using a row-based scan order. For example, if a 1D primary transform is applied row-wise, the primary transform coefficients in each row are vectorized using a row-wise scan order as shown in FIG. 4E. In this example, a secondary transform is applied on the vectorized coefficients from each row. In some embodiments, the vectorization process creates a single column vector with multiple entries, for example, a 1×48 vector with 6 entries for each of 8 rows (where the last two entries from each of the 8 rows are removed as indicated by the excluded high-frequency columns). In some embodiments, the row-wise scan order processes coefficients sequentially from left to right within each row, then proceeds to the next row. In some embodiments, the directional vectorization scheme aligns with the primary transform direction, using row-based scan orders for row-wise transforms to optimize the secondary transform application. In some embodiments, the vectorized coefficients from the support region are then processed by the secondary transform to further reduce redundancy in the transform coefficients.

(A5) In some embodiments of any of A1-A4, the method further comprising when the 1D primary transform is applied column-wise, vectorizing coefficients in each column using a column-based scan order. For example, if 1D primary transform is applied column-wise, the primary transform coefficients in each column are vectorized using a column-wise scan order as shown in FIG. 4F. In this example, a secondary transform is applied on the vectorized coefficients from each column. In some embodiments, the column-wise scan order processes coefficients sequentially from top to bottom within each column, then proceeds to the next column. In some embodiments, the vectorization creates a vector that excludes the high-frequency rows (e.g., the last two rows) from the support region. In some embodiments, the directional vectorization scheme uses column-based scan orders for column-wise transforms to match the directionality of the primary transform. In some embodiments, the column-wise vectorization provides enhanced coding quality by matching secondary transform characteristics to the specific directionality patterns created by column-wise 1D primary transforms. In some embodiments, the vectorized coefficients are arranged to facilitate efficient application of the secondary transform matrix operations.

(A6) In some embodiments of any of A1-A5, the method further comprising selecting the 1D primary transform from a set of 1D primary transforms. For example, multiple transform sets with multiple kernels in each set may be used for transform blocks using 1D primary transform. In some embodiments, the set of 1D primary transforms includes different types of sinusoidal transforms such as DCT's, DST's, flipped versions of DCT's and ADST's. In some embodiments, the set of 1D primary transforms includes Karhunen-Loève Transform (KLTs), Learned Group Transform (LGTs), or Data Driven Trained Transforms (DDT). In some embodiments, the selection of the 1D primary transform is based on characteristics of the current block, such as prediction mode, block size, or content characteristics. In some embodiments, the 1D primary transform is selected to optimize the energy compaction for the specific directional characteristics of the residual data in the current block. In some embodiments, the selection process involves evaluating multiple candidate transforms and choosing the one that provides the best rate-distortion performance for the current block.

(A7) In some embodiments of any of A1-A6, the secondary transform is selected from a set of transforms based on a transform type of the 1D primary transform. For example, different transform sets and kernels may be used for different 1D primary transform types. In some embodiments, for the same 1D primary transform type, different transform sets and kernels are used based on the support regions (e.g., as shown in FIGS. 4B, 4C, 4D, 4E, and 4F). In some embodiments, different secondary transform sets correspond to different matrices, such as non-separable matrices that may be derived from data. In some embodiments, for the same 1D primary transform type, different transform sets and kernels may be used depending on whether the primary transform is applied row-wise or column-wise. In some embodiments, the secondary transform is derived based on the primary transforms that are used, and the matrices or kernels may include hard coded values in a table of values, with a specific matrix being selected based on the 1D primary transform. In some embodiments, unique or common secondary transform sets may be defined for each primary transform type, and/or intra or inter mode type. In some embodiments, the secondary transform sets include groupings of one or more secondary transform kernels, where each entry in the transform set is called a transform candidate. In some embodiments, the transform candidate selected from a transform set may be signaled or implicitly identified for performing the forward/backward transform process.

(A8) In some embodiments of any of A1-A7, a transform kernel size of the 1D primary transform is based on a size of the current block. {For example, transform kernels of different sizes may be used for transform blocks of different sizes. For example, for transform blocks with width or height ≤8, a support region with width or height ≤4 is defined. In this case, the kernel size is M×N wherein (M≤4 and N≤4). In another example, for transform blocks with width or height ≥8, a support region with width or height ≤8 is defined. In this case, the kernel size is M×N wherein (M≤8 and N≤8). In some embodiments, the transform kernel size adaptation based on block dimensions optimizes computational efficiency by using appropriately sized kernels for different block sizes. For example, smaller blocks use smaller kernel sizes to avoid over-parameterization, while larger blocks can accommodate larger kernel sizes to capture more complex transform relationships. In some embodiments, the kernel size selection provides a balance between transform efficiency and computational complexity. In some embodiments, the kernel size is determined based on both the width and height dimensions of the current block, with the smaller dimension determining the maximum kernel size. In some embodiments, different kernel sizes may be used for the same block size depending on the specific 1D primary transform type and the support region configuration.

(B1) In another aspect, some embodiments include a method (e.g., the method 550) of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks, including a current block; and (ii) when a one-dimensional (1D) primary transform is used for the current block: (a) determining a support region based on the 1D primary transform; (b) selecting a secondary transform based on the 1D primary transform and the support region; and (c) encoding the current block using the secondary transform. In some embodiments, the method further includes transmitting encoded information for the current block in a video bitstream. In some embodiments, the method further includes transmitting encoded information for the current block in a video bitstream. In some embodiments, the video data comprises a source video sequence that can be of any suitable bit depth (e.g., 8-bit, 10-bit, or 12-bit), any colorspace (e.g., Y CrCb, or RGB), and any suitable sampling structure (e.g., Y CrCb 4:2:0 or Y CrCb 4:4:4). In some embodiments, the encoding process mirrors the decoding process but applies the transforms in forward direction during encoding. In some embodiments, the encoding method provides reduced encoding time by constraining the secondary transform to optimally-sized support regions rather than processing entire transform blocks. In some embodiments, the method includes generating a residual block by subtracting a prediction block from the current block, applying the 1D primary transform to the residual block, and then applying the secondary transform to the specified support region of the primary transform output.

(B2) In some embodiments of B1, the secondary transform is applied when the 1D primary transform is applied to one of: one or more rows of the current block, or one or more columns of the current block. In some embodiments, the encoding process determines whether to apply the 1D primary transform row-wise or column-wise based on the characteristics of the residual data. In some embodiments, the decision between row-wise and column-wise application is based on the directionality of the residual patterns in the current block. In some embodiments, row-wise application is preferred when the residual data exhibits horizontal correlations, while column-wise application is preferred when the residual data exhibits vertical correlations. In some embodiments, the choice between row-wise and column-wise application may be signaled in the bitstream or derived implicitly based on other coding parameters. In some embodiments, the secondary transform application is specifically enabled for blocks using 1D primary transforms to exploit the directional characteristics introduced by the 1D transform process.

(B3) In some embodiments of B1 or B2, the support region is based on whether the 1D primary transform is horizontal or vertical. In some embodiments, the support region determination during encoding follows the same principles as during decoding, where row-wise transforms utilize support regions that exclude high-frequency columns, and column-wise transforms utilize support regions that exclude high-frequency rows. In some embodiments, the encoder evaluates different support region configurations to determine the optimal region for the current block. In some embodiments, the support region selection is based on the energy distribution of the transform coefficients after the 1D primary transform is applied. In some embodiments, the encoder tests multiple support region configurations and select the one that provides the best rate-distortion performance. In some embodiments, the support region configuration is adapted based on the content characteristics of the current block, such as texture complexity or edge orientation.

(B4) In some embodiments of any one of B1-B3, the method further comprising, when the 1D primary transform is applied row-wise, vectorizing coefficients in each row using a row-based scan order. In some embodiments, the encoding process performs the same vectorization as the decoding process to ensure consistency. In some embodiments, the row-based scan order during encoding creates the same vector arrangement that will be expected during decoding. In some embodiments, the vectorization process during encoding may involve reordering the coefficients to optimize the subsequent secondary transform application. In some embodiments, the encoder may evaluate different scan orders within the row-based approach to determine the most efficient arrangement for the secondary transform. In some embodiments, the vectorization process is designed to align with the directional characteristics of the row-wise 1D primary transform to maximize the effectiveness of the secondary transform.

(B5) In some embodiments of any one of B1-B4, the method further comprising, when the 1D primary transform is applied column-wise, vectorizing coefficients in each column using a column-based scan order. In some embodiments, the column-based vectorization during encoding follows the same pattern as during decoding to maintain consistency in the transform process. In some embodiments, the encoder ensures that the column-based scan order produces a vector arrangement that can be properly processed by the secondary transform. In some embodiments, the vectorization process may be optimized based on the specific characteristics of the column-wise 1D primary transform output. In some embodiments, the encoder adapts the column-based scan order based on the energy distribution of the coefficients within each column. In some embodiments, the vectorization process is designed to facilitate efficient matrix operations during the secondary transform application.

(B6) In some embodiments of any one of B1-B5, the method further comprising selecting the 1D primary transform from a set of 1D primary transforms. In some embodiments, the encoder evaluates multiple 1D primary transform candidates and selects the one that provides the best coding performance for the current block. In some embodiments, the selection process involves rate-distortion optimization to choose the optimal 1D primary transform. In some embodiments, the encoder considers the characteristics of the residual data, such as directionality and energy distribution, when selecting the 1D primary transform. In some embodiments, the selection may be based on the prediction mode used for the current block, with different transforms being preferred for different prediction modes. In some embodiments, the encoder may use machine learning techniques or statistical analysis to determine the most suitable 1D primary transform for the current block. In some embodiments, the selected 1D primary transform information may be signaled in the bitstream or derived implicitly based on other coding parameters.

(B7) In some embodiments of B1-B6, the secondary transform is selected from a set of transforms based on a transform type of the 1D primary transform. In some embodiments, the encoder maintains multiple secondary transform sets, each optimized for different types of 1D primary transforms. In some embodiments, the secondary transform selection process involves evaluating the compatibility between the 1D primary transform characteristics and the available secondary transform options. In some embodiments, the encoder may use training data or statistical analysis to determine the optimal secondary transform for each 1D primary transform type. In some embodiments, the secondary transform selection may also consider the support region configuration and the directionality of the 1D primary transform. In some embodiments, the encoder may perform rate-distortion optimization to select the best secondary transform from the available set. In some embodiments, the selected secondary transform information may be explicitly signaled in the bitstream or derived implicitly based on the 1D primary transform type and other coding parameters.

(C1) In another aspect, some embodiments include a method of video encoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) determining a support region based on the 1D primary transform; (ii) selecting the secondary transform based on the 1D primary transform and the support region; and (iii) encoding the current block using the secondary transform. The video bitstream comprises coded information for a plurality of blocks including a current block. The coded information includes information for a set of coefficients for the current block, the set of coefficients generated using a one-dimensional (1D) primary transform and a secondary transform. In some embodiments, the video bitstream comprises an indicator indicating an index value for the secondary transform set.

(C2) In some embodiments of C1, the secondary transform is applied when the 1D primary transform is applied to one of: one or more rows of the current block, or one or more columns of the current block.

(C3) In some embodiments of C1 or C2, the support region is based on whether the 1D primary transform is horizontal or vertical.

(C4) In some embodiments of any of C1-C3, the secondary transform is selected from a set of transforms based on a transform type of the 1D primary transform.

(C5) In some embodiments of any of C1-C4, a transform kernel size of the 1D primary transform is based on a size of the current block.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A8, B1-B7, and C1-C5 above).

In yet another aspect, some embodiments include a non-transitory computer-readable storage medium storing one or more sets of instructions for execution by control circuitry of a computing system, the one or more sets of instructions including instructions for performing any of the methods described herein A1-A8, B1-B7, and C1-C5 above).

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context. As used herein, N refers to a variable number. Unless explicitly stated, different instances of N may refer to the same number (e.g., the same integer value, such as the number 2) or different numbers.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block; and
when a one-dimensional (1D) primary transform is used for the current block:
determining a support region based on the 1D primary transform;
selecting a secondary transform based on the 1D primary transform and the support region; and
reconstructing the current block using the secondary transform.

2. The method of claim 1, wherein the secondary transform is applied when the 1D primary transform is applied to one of: one or more rows of the current block, or one or more columns of the current block.

3. The method of claim 1, wherein the support region is based on whether the 1D primary transform is horizontal or vertical.

4. The method of claim 1, further comprising, when the 1D primary transform is applied row-wise, vectorizing coefficients in each row using a row-based scan order.

5. The method of claim 1, further comprising, when the 1D primary transform is applied column-wise, vectorizing coefficients in each column using a column-based scan order.

6. The method of claim 1, further comprising selecting the 1D primary transform from a set of 1D primary transforms.

7. The method of claim 1, wherein the secondary transform is selected from a set of transforms based on a transform type of the 1D primary transform.

8. The method of claim 1, wherein a transform kernel size of the 1D primary transform is based on a size of the current block.

9. A method of video encoding performed at a computing system having memory and one or more processors, the method comprising:
receiving video data comprising a plurality of blocks, including a current block; and
when a one-dimensional (1D) primary transform is used for the current block:
determining a support region based on the 1D primary transform;
selecting a secondary transform based on the 1D primary transform and the support region; and
encoding the current block using the secondary transform.

10. The method of claim 9, wherein the secondary transform is applied when the 1D primary transform is applied to one of: one or more rows of the current block, or one or more columns of the current block.

11. The method of claim 9, wherein the support region is based on whether the 1D primary transform is horizontal or vertical.

12. The method of claim 9, further comprising, when the 1D primary transform is applied row-wise, vectorizing coefficients in each row using a row-based scan order.

13. The method of claim 9, further comprising, when the 1D primary transform is applied column-wise, vectorizing coefficients in each column using a column-based scan order.

14. The method of claim 9, further comprising selecting the 1D primary transform from a set of 1D primary transforms.

15. The method of claim 9, wherein the secondary transform is selected from a set of transforms based on a transform type of the 1D primary transform.

16. A non-transitory computer-readable storage medium storing a video bitstream that is generated by a video encoding method, the video bitstream comprising:
coded information for a plurality of blocks including a current block, wherein the coded information includes information for a set of coefficients for the current block, the set of coefficients generated using a one-dimensional (1D) primary transform and a secondary transform; and
wherein the video encoding method comprises:
determining a support region based on the 1D primary transform;
selecting the secondary transform based on the 1D primary transform and the support region; and
encoding the current block using the secondary transform.

17. The non-transitory computer-readable storage medium of claim 16, wherein the secondary transform is applied when the 1D primary transform is applied to one of: one or more rows of the current block, or one or more columns of the current block.

18. The non-transitory computer-readable storage medium of claim 16, wherein the support region is based on whether the 1D primary transform is horizontal or vertical.

19. The non-transitory computer-readable storage medium of claim 16, wherein the secondary transform is selected from a set of transforms based on a transform type of the 1D primary transform.

20. The non-transitory computer-readable storage medium of claim 16, wherein a transform kernel size of the 1D primary transform is based on a size of the current block.
